(19) United States
(12) Patent Application Publication
(10) Pub. No.: US 2021/0381425 A1
(43) Pub. Date: Dec. 9, 2021

(54) ROTARY VANE INTERNAL COMBUSTION ENGINE

(71) Applicant: Anatoli Stanetsky, Brooklyn, NY (US)

(72) Inventor: Anatoli Stanetsky, Brooklyn, NY (US)

(21) Appl. No.: 16/894,775

(22) Filed: Jun. 6, 2020

(51) Int. Cl. F02B 55/02; F02B 55/10; F02B 53/10; F02B 55/14; F01C 21/06; F01C 21/00; F01C 1/02

(52) U.S. Cl. CPC F02B 55/02; F02B 55/10; F02B 53/10; F01C 1/02; F01C 21/06; F01C 21/008; F02B 55/14

(57) ABSTRACT

Rotary vane internal combustion engine comprises of two rotors, nested in each other, placed in a cylindrical housing, wherein each rotor has at least two radial vanes rigidly attached to the rotor that form chambers for intake, compression, combustion, and exhaust. Each rotor, alternately engages with a shaft by overrunning one-way clutches and held from turning back, through the cushioning mechanisms, mounted on flywheels, which are rigidly attached on the shaft, wherein the assembled rotors from the outside are rigidly closed by flanges on each of which is mounted at least one blade, which are placed into formed cavity between rotors and caps of the housing thereby forming two cooling chambers through which coolant circulates around rotors through openings in the housing and through longitudinal grooves in the shaft. On the vanes mounted cylindrical and conical seals that exclude the need for lubrication.

### CROSS-REFERENCE TO RELATED APPLICATIONS

International Classification: F01C1/02, F01C1/08, F01C1/22, F01C1/24; F01C1/063; F02B 53/00; F02B 55/00; F02B053/00;

Current U.S. Classification: 123/18.00R, 41 R, 192.1, 143 R+, 200, 213, 215, 217, 222, 227 234, 237, 242, 245, 239, 293, and 306; 356/216; 418/13, 33, 89, 93, 99, 147, 156, 268; 61/187,866; 74/437;

Class Search: 60/597,616; 61/187,866; 123/18.00R, 41 R, 192.1, 143 R+, 200, 204, 213, 215, 217, 222, 243, 231, 236, 237, 242, 239, 293, 306, 568; 384/99, 109, 111; 418/13, 33, 36, 89, 91, 92, 93, 97, 98, 129, 138, 141, 143, 147, 156, 268;

### STATEMENT ABOUT FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### 1. Field of the Invention

The present invention relate to rotary machines. More specifically, the invention pertains to a rotary internal combustion engines having a plurality of rotatable vanes.

### 2. Description of the Related Art

Current designs of rotary vane internal combustion engines have serious disadvantages: complicated mechanisms for coordinating movement of the rotors (vanes), increased temperature and wear of surfaces due to friction, availability of reciprocation of working elements. Existing work in US patents and foreign patents:

The closest prototype is a rotary machine, Russian Pat. No. RU2135777C1, comprising a body, a cylinder, two side covers, coaxial shafts; four vanes rigidly mounted on each rotor and placed in a cylinder to form chambers, driving shaft installed in housing eccentrically relative to coaxial shafts and driving member fitted on shaft. Two hinge joints made on driving member accommodate tie-rod connected with single-arm levers rigidly installed on coaxial shafts. Cylinder is provided with suction port and number of delivery holes which can be overlapped to provide control of gas pressure at outlet. However, such a rotary machine described a mechanism for converting the movement of vanes still has large dimensions. The mechanism of coordination of movement of vanes, its diameter and width on many more than the size of the working chamber where there are running cycles. Not eliminated the alternating shock loads because do not provide guaranteed gap acceleration and deceleration of working rotors. Disadvantages of this rotary machine and this type of rotary engines are related to difficulties removing the power from two different shafts, each connected to its communication mechanism with vanes that move irregularly and impulsively. Removing power from such shafts of the proposed method is extremely difficult. The required approval of their motion relative to each other is performed using extremely complex and cumbersome mechanism for synchronization. The huge inertial loadings destroy the applied mechanisms of coordination of rotation shafts and related rotor vanes. A shortcoming of the present invention is rather high temperature of rotors and their vanes. And serious problem of the engine is the seal of clearances and lubrication of working surfaces of the rotor vanes.

This specification discloses a rotary vane internal combustion engine, U.S. Pat. No. 3,762,375A, comprising a casing defining a rotor chamber of a shape resembling an ellipse. A shaft is journaled in the casing centrally thereof and drivable mounted on the shaft is a rotor presenting a cylindrical surface. The rotor is formed with a plurality of radial slots and sliceable in each slot is a vane. The rotor is also formed with a plurality of combustion chambers opening onto its cylindrical surface. The number of combustion chambers is the same as the numbers of slots with a chamber being located between two adjacent slots. An intake port for an air, gas, oil mixture is formed in the casing and communicating with this port is a pair of channels formed in the casing on opposite sides of the rotor chamber. These channels pass about the shaft where it is journaled in the casing and open onto the rotor chamber at points diametrically opposite to the intake port. A manifold type exhaust is formed in the casing about 30 degree, in the direction of rotation of the rotor from the intake port. A spark plug is mounted on the casing with its points located at the periphery of the rotor chamber. Conductors extend from the spark plug to contacts mounted on the exterior of the casing with the contacts being bridged at periodic intervals by a cam drivable mounted on the shaft. The shaft also drivable carries a gear with which meshes a pinion that is driven by a starting motor.

A rotary-vane internal combustion engine, U.S. Pat. No. 4,403,581 A, comprising, in combination, a rotary compressor for forming and igniting a combustible fluid mixture, a rotary power unit, and an expansion chamber that is connected both to the compressor for receiving the ignited mixture, and to the power unit, where the power developed by the expanding ignited combustible mixture in the expansion chamber drives a vane acting on a driven member. In each of the compressor and power units respective rotors are mounted for rotation. A plurality of vanes rotatable supported by a shaft within each rotor rotates with the rotor and slide in slots in guides mounted with the rotor. The rotor within the compressor is mounted eccentrically so that the fluid is compressed before it is ignited and leaves the compressor. The combustible fluid, after ignition, enters the expansion chamber where it drives one or more vanes coupled to the rotor mounted eccentrically within the rotary power unit. The rotor of the power unit is provided with a plurality of slotted guides receiving the vanes as they rotate through the expansion chamber. The vanes slide within the slotted guides and are maintained in constant alignment therewith by an arm coupled to each of the guides and to the rotor shaft, which is an important feature as the vanes of the power rotor leave, at some point during the operation of the engine, their respective slotted guides.

Rotary machines utilizing rotatable vanes attached to a stationary center shaft and extending through a rotatable off-center hollow cylindrical rotor into sliding contact with the wall of a housing are known in the prior art. U.S. Pat. No. 3,892,502 issued to E. Pritchard and U.S. Pat. No. 3,976,403 issued to R. L. Jensen is exemplary of such machines. A problem with some prior art rotary vane machines is that they cannot successfully operate under high pressure and heat. This is inability to operate under high pressure and heat due to poor seals on the vanes and high torque on the vanes.

U.S. Pat. No. 6,681,738, the rotary type fluid machine, vane type fluid machine, includes a casing, a rotor and a plurality of vane-piston units which are disposed in a radiate arrangement on the rotor. Each of the vane-piston units has a vane sliding in a rotor chamber and a piston placed in abutment against an on-slide side of the vane. When it functions as an expanding machine, the expansion of a high pressure gas is used to operate the pistons thereby to rotate the rotor via vanes and the expansion of a low pressure gas caused by a pressure reduction in the high pressure gas is used to rotate the rotor via the vanes. On the other hand, when it functions as a compressing machine, the rotation of rotor is used to supply a low pressure air to the side of pistons via vanes and further, the pistons are operated by the vanes to convert the low pressure air to the high pressure air. Thus, a rotary type fluid machine having expanding and compressing functions, with the merits belonging to the piston type and the merits belonging to the vane type, can be provided.

U.S. Pat. No. 6,675,765 B2, rotary type fluid machine includes a casing, a rotor and a plurality of vane-piston units which are disposed on the rotor. Each of the vane-piston units has a vane sliding in a rotor chamber and a piston placed in abutment against a non-slide side of the vane. When it functions as an expanding machine, the expansion of a high pressure gas is used to operate the pistons thereby to rotate the rotor via vanes and the expansion of a low pressure gas caused by a pressure reduction in the high pressure gas is used to rotate the rotor via the vanes. On the other hand, when it functions as a compressing machine, the rotation of rotor is used to supply a low pressure air to the side of pistons via vanes and further, the pistons are operated by the vanes to convert the low pressure air to the high pressure air. Thus, a rotary type fluid machine having expanding and compressing functions, with the merits belonging to the piston type and the merits belonging to the vane type, are in confined space where heat removal is significantly impeded. In addition, the vanes have a return-translational movement that aggravates the operation of the mechanism and at high temperatures will jam.

U.S. Pat. No. 4,848,296 A, the rotary internal combustion engine, comprises a cylindrical casing and a cylindrical rotor. Several stepped crankshafts rotatable connected to the rotor pass through the ends of the casing, thereby confining motion of the rotor to orbital motion. Radial vanes extend from an axial shaft in the casing to the inner surface of the casing wall and form seals against the casing. Combustion chambers are formed between adjacent vanes. Intake, exhaust, and ignition systems provide a combustion cycle for each chamber as the rotor orbits and cannot be cooled and cannot readily be lubricated so is very susceptible to overheating, which keeps it from being usable, and can't eliminate the reciprocating movement of the vanes.

U.S. Pat. No. 4,241,713 A is a rotary internal combustion engine, having housing defining chambers through which extends coaxially shaft. A plurality of vanes is pinned to a collar which is relative about the shaft. One vane is rigidly secured to the collar. A cylindrical drum is positioned in the working chamber with the centerline of the drum radially offset from the centerline of the working chamber. The vanes extend through slots or apertures in the rotor to close proximity with the chamber wall. A fuel delivery system communicates with the chamber through approximately 90 degrees of the compression cycle. An exhaust opening communicates with the chamber at the end of the expansion cycle whereby the compression ratio is substantially less than the expansion ratio. In one embodiment means are provided to vary the compression and expansion ratios, and cannot be cooled and cannot readily to be lubricated, are very susceptible to overheating. This keeps it from being usable and can't eliminate the reciprocating movement of the vanes.

U.S. Pat. No. 3,964,447A is a rotary vane internal combustion engine, which includes two separate housings, compressor, housing and a motor housing. A rotor is rotatable mounted in each housing and includes a system of partially unbalanced vanes slid ably mounted in these openings and bearing at each extremity thereof against the interior profile of the related housing. Each vane defines in the housing chambers of variable volume depending on the relative rotational position of each segment with respect to the housing profile. Both housings are similarly structured with the exception that the compressor housing includes two sections of constant radius. The each housing includes inlet and outlet meant for the entry and exhaust of fluids. The vanes working under load having the reciprocating movement cannot be cooled and cannot readily to be lubricated so are very susceptible to overheating, which prevents it from being usable.

U.S. Pat. No. 3,955,540 A, the rotary internal combustion engine, which includes a housing having a cylindrical inner peripheral wall surface, a hollow, cylindrical rotor rotatable shaft-mounted in the housing in eccentric relationship with respect to the housing, a cylindrical vane track positioned in the hollow cavity of the rotor and located in the center of the housing, and vanes slide and radially disposed in the walls of the rotor and adapted to traverse the vane track and inner peripheral wall surface of the housing as the rotor rotates. The rotor and vanes cooperate with the housing to define a plurality of chambers which become successively smaller as they are charged with fuel and approach the firing area of the housing, and larger after combustion as they approach the exhaust and intake segments of the housing, cannot be cooled and cannot readily to be lubricated so are very susceptible to overheating, and prevents it from being usable.

U.S. Pat. No. 6,070,565 A, the rotary internal combustion engine, wherein the rotor has a plurality of vane slots therein and a vane control shaft is mounted at a predetermined fixed position within the center portion of the rotor and has two end portions, one of which is fixedly attached to the engine housing chamber base and at least two vane position control portions positioned between the end portions, so that nested rotors driven crankshaft of the engine. Rotors at the same time, have a complex movement and conditions and can't be cooled and can't readily to be lubricated so there is very susceptible to overheating, which prevents it from being usable.

U.S. Pat. No. 5,305,721 A, the rotary Wankel type internal combustion engine system is disclosed, wherein the crankshaft is supported by a center main roller bearing. The rotor apexes are sealed by two piece apex seals and by side seals. The engine system further includes an oiling system which permits oil flow through the center bearing and through lubrication passages in the engine rotor to provide a means for cooling the engine rotor under high loading conditions. Riblets are defined in the combustion face of the rotor to promote aerodynamic lateral stratified charge control to minimize atomized fuel charge loss to surface wetting before ignition.

U.S. Pat. No. 4,004,556, the rotary internal combustion engine of axial sliding vane type, has sinusoidal shaped side walls with compensation of the mass forces allowing nearly friction-free and high speed operation with sufficient compression ratio. High power output is believed to make the invention comparable to the well-known Wankel engine. The various designs of the rotary machines can also be used as fluid pumps or fluid-operated motors.

U.S. Pat. No. 4,403,581A, the rotary-vane internal combustion engine comprising in combination, a rotary compressor for forming and igniting a combustible fluid mixture, a rotary power unit, and an expansion chamber that is connected both to the compressor for receiving the ignited mixture, and to the power unit, where the power developed by the expanding ignited combustible mixture in the expansion chamber drives a vane acting on a driven member. In each of the compressor and power units respective rotors are mounted for rotation. A plurality of vanes rotatable supported by a shaft within each rotor rotates with the rotor and slide in slots in guides mounted with the rotor. The rotor within the compressor is mounted eccentrically so that the fluid is compressed before it is ignited and leaves the compressor. The combustible fluid, after ignition, enters the expansion chamber where it drives one or more vanes coupled to the rotor mounted eccentrically within the rotary power unit. The rotor of the power unit is provided with a plurality of slotted guides receiving the vanes as they rotate through the expansion chamber. Disadvantage is that the vanes slide within the slotted guides and are necessary to maintained in constant alignment therewith by an arm coupled to each of the guides and to the rotor shaft, which is an important negative feature as the vanes of the power rotor leave, at some point during the operation of the engine, their respective slotted guides can be destroyed.

U.S. Pat. No. 4,476,826, a rotary internal combustion engine, having a stationary casing, and a rotor mounted for rotation about an axis eccentric to the casing forming a crescent shaped compression chamber and a separate crescent shaped expansion chamber. Intake and exhaust ports in the casing respectively communicate with the compression and expansion chambers and first and second vanes angularly spaced apart on the rotor slid ably engage the walls of the respective compression and expansion chambers. A rotary transfer valve is provided on the rotor intermediate the first and second vanes to alternately communicate with the compression and expansion chambers. The charge of combustible mixture is ignited while in the transfer valve. When the charge of the combustible mixture ignited it is practically difficult to coordinate the radial movement of the blade with the cam, where the rotational and translational movements must coincide

U.S. Pat. No. 5,086,732, the four stroke concentric oscillating rotary vane internal combustion engine performs the four stroke Otto cycle inside four arcuate combustion chambers formed between the shell, rotor cylinder and two transverse end plates analogous to the engine cylinder; two fixed diametrically opposed vanes inwardly projecting from the shell serving as cylinder heads; and two fixed diametrically opposed vanes projecting outwardly from the rotor cylinder functioning as pistons. An output shaft mechanism orchestrates the synchronized operations of the fuel injection and spark ignition systems, pair of cranking mechanisms controlling the rotary strokes of the rotor, and pair of forced porting mechanisms forcing the complete removal of combustion byproducts from and sufficient supply of air into the combustion chambers. The big disadvantage is that the output shaft of forced porting mechanism forcing orchestrating the synchronized operations of the fuel injection and spark ignition systems.

U.S. Pat. No. 5,277,158, the multiples vane rotary internal combustion engine, a three-piece housing enclosing a cavity has rotatable mounted therein a rotor having a plurality of slots, each slot supporting a vain. Each vane has a retention end guided in its revolution around the rotor by an internal, non-circular vane retention track. Two adjacent vanes define opposite sides of a combustion chamber, while the housing and the portion of the rotor between the adjacent vanes form the remaining surfaces of the combustion chamber. Each combustion chamber is rotated past an intake port, a diagonal plasma bleed-over groove, and an exhaust port to accomplish the phases of a combustion cycle. Fuel ignition is provided to more than one combustion chamber at a time by expanding gases passing through a plasma bleed-over groove and being formed into a vortex that ignites and churns the charge in a succeeding combustion chamber. Exhaust gases remaining after primary evacuation are removed by a secondary evacuation system utilizing a venture creating negative pressure which evacuates the combustion chamber. Lubrication is circulated through the engine without the use of a lubricant pump. The centrifugal force of the rotating rotor causes the lubricant therein to be pressurized thereby drawing additional lubricant into the closed system and forcing lubricant within the engine to be circulated.

However it is difficult work, a very complex rotor with many grooves, with each slot supporting a void. Each blade must be held during a shocking movement guided by rotation around the rotor along the inner non-circular guide to hold the blade.

U.S. Pat. No. 6,550,443B1, a rotary internal combustion engine has a cylindrical rotor which rotates in a cylindrical rotor chamber of a stator. A cylindrical peripheral surface of the rotor rotates equidistantly from the housing wall of the rotor housing. A plurality of vanes project radially from the peripheral surface of the rotor are sealing against the inner wall surface of the rotor housing. Several turning or reciprocating valves are equal-angularly distributed about periphery of the housing chamber. The valves seal against the rotor periphery and they open up for the vanes to pass by.

U.S. Pat. No. 6,513,482, the rotary type fluid machine includes a casing, a rotor and a plurality of vane-piston units, which are disposed in a radiate arrangement on the rotor. Each of the vane-piston units has a vane sliding in a rotor chamber and a piston placed in abutment against a non-slide side of the vane. When it functions as an expanding machine, the expansion of a high pressure gas is used to operate the pistons thereby to rotate the rotor via vanes and the expansion of a low pressure gas caused by a pressure reduction in the high pressure gas is used to rotate the rotor via the vanes. On the other hand, when it functions as a compressing machine, the rotation of rotor is used to supply a low pressure air to the side of pistons via vanes and further, the pistons are operated by the vanes to convert the low pressure air to the high pressure air. Thus, a rotary type fluid machine having expanding and compressing functions, with the merits belonging to the piston type and the merits belonging to the vane type, can be provided.

The rotor and a plurality of vane-piston assemblies that are located in a radiation arrangement on the rotor have a translational and rotational movement, which greatly complicate and renders the whole process unreliable.

U.S. Pat. No. 6,668,786, rotary type fluid machine includes a casing, a rotor and a plurality of vane-piston units which are disposed in a radiate arrangement on the rotor. Each of the vane-piston units has a vane sliding in a rotor chamber and a piston placed in abutment against a non-slide side of the vane. When it functions as an expanding machine, the expansion of a high pressure gas is used to operate the pistons thereby to rotate the rotor via vanes and the expansion of a low pressure gas caused by a pressure reduction in the high pressure gas is used to rotate the rotor via the vanes. On the other hand, when it functions as a compressing machine, the rotation of rotor is used to supply a low pressure air to the side of pistons via vanes and further, the pistons are operated by the vanes to convert the low pressure air to the high pressure air. Thus, a rotary type fluid machine having expanding and compressing functions, with the merits belonging to the piston type and the merits belonging to the vane type, can be provided.

U.S. Pat. No. 7,077,098, a rotary internal combustion engine has a hollow stator with inner surface formed by two concentric cylindrical surfaces, which fluently transit one into the other via ramp surfaces, and a cylindrical rotor, having the same radius as smaller concentric surface of the stator. The rotor has vanes that move radially within the rotor tightly contouring the inner surface of the stator during rotor rotation. The cavities within the stator where its inner radius equals that of the rotor constitute combustion chambers, which connect to the variable-volume working chambers formed by outer surface of the rotor, inner surface of the stator with bigger radius and the side of the vane via valve-controlled orifices ending in the areas of the stator ramp surfaces. During rotor rotation the vanes provide compression of fuel mixture into combustion chambers and accept the energy of expanding gasses following fuel mixture ignition in the combustion chamber.

U.S. Pat. No. 9,546,594 a guided-vane rotary internal combustion engine including a plurality of working chambers which are separated from one another by way of vane assemblies which rotate with a rotor assembly about an axis employs a rotor assembly having a plurality of sectors wherein each sector is associated with a corresponding working chamber and a plurality of spark plugs wherein each spark plug is mounted within a corresponding sector for igniting an air/fuel mixture contained within a corresponding working chamber. A rotor disk is mounted upon the rotor assembly for rotation therewith and acts as a distributor through which energizing charges are conducted to the spark plugs. In addition, a controller is utilized for selectively activating or de-activating the working chambers of the engine upon the occurrence of a predetermined event.

U.S. Pat. No. 9,850,835 a guided-vane rotary internal combustion engine including a plurality of working chambers which are separated from one another by way of vane assemblies which rotate with a rotor assembly about an axis employs a rotor assembly having a plurality of sectors wherein each sector is associated with a corresponding working chamber and a plurality of spark plugs wherein each spark plug is mounted within a corresponding sector for igniting an air/fuel mixture contained within a corresponding working chamber. A rotor disk is mounted upon the rotor assembly for rotation therewith and acts as a distributor through which energizing charges are conducted to the spark plugs. In addition, a controller is utilized for selectively activating or de-activating the working chambers of the engine upon the occurrence of a predetermined event.

The US patent application 20050016494A1, known as four-cycle rotary engines with an even number of hinged-hub impeller vanes, utilize dependently rotating, joined, hinged-hub impellers, with interdigitated, alternating hub sections, on a shared, power output shaft, and electromagnetic fields, and timing of impeller release and capture, to provide real time compression ratio control, and to control the momentum of the rotating impellers, and mechanical clutches to transfer the rotation to the power shaft.

The US patent application 20100258075A1, known as rotary internal combustion engine consisting of stator and two co-axial rotors with two vanes on each by introducing in it the reducing gear, including main shaft, rotors shafts and auxiliary device shaft, on which the two-tooth gears are mounted. The crown of the two-tooth gears has a shape of mating convex and concave arcs, which teeth meshing ensures a kinematic interaction of the rotor shaft gears with the main shaft gears and with the auxiliary device gears. The mechanism ensures reliable transmission of torsion torques from rotors shafts to the power take-off shaft, optimum compression degree of air-fuel mixture in the compression and combustion chambers, a rational correlation between the maximum and minimum rotors revolution velocity during their operation, given relative position of rotors, shafts and gears in a static, pre-starting state of the engine.

Internal combustion engines (WO/2016/099313) has a simple, efficient rotary-vane-type construction, with two movable gas-distribution paddle valves, which, depending on the selected construction, are controllable by means of electric drives, pneumatic drives, hydraulic drives controllable by electronics, or mechanically with the aid of distribution shafts drivable with a chain or a belt. A rotary-vane-type steam-driven pneumatic engine has an analogous construction, with the exception of controllable paddle valves not being present. Novelty: the engine has a rotary-vane-type construction, with two movable and controllable gas-distribution paddle valves. The rotary-vane-type steam-driven pneumatic engine has an analogous construction, with the exception of controllable paddle valves not being present.

Most of the above inventions have the following imperfections:
The presence of reciprocating movement of the working elements;
The use of complex and unreliable mechanisms to synchronize movement between the vanes;
Lack of cooling of the working area of the engine;
Lack of the possibility of intensive lubrication of working surfaces.

In the particular version of invention my embodiment new design of a rotary vane internal combustion engine, which eliminates the above disadvantages, it does not use reciprocating mechanisms and there is no need to synchronize the rotation of the rotors, since the rotors do not have a rigid connection with shaft. Proposed engine has intensive cooling and is not subject to overheating.

### Foreign Patent Documents:

### 2008/0276903A1; 2005/0016494A1; RU2135777C1 (RF2135777); RU2054122; RF2177063; RF2117766; RF2281400; RU3477377C2; RU2447376C2; WO/2016/099313A1

### Toyota Motor Corp.:

### Y02T10/18; Y02T10/62; Y02T10/144; Y02T10/14; Y02T10/00; Y02T10; Y02T; Y02T10/10; B60L2240/48; F01L1/3442; F01L1/344; F01L1/34; F01L1/00; F01L1; F01L; F01L2001/3445; F16H61/662; F16H61/66272; F16H61/66; F01L1/34406; F01L1/34403.

### Hitachi, Ltd.:

### F02D41/00; F02D41; F02D41/30; F01L1/02; Y02T10/40; F01L2001/34453; F01L1/3442; F01L1/344; F02D; F01L2001/3445; F01L1/34; F01L1/00.

### Denso Corporation:

### H02K51/00; Y02T10/6243; B60K6/448; B60W2710/06; B60W10/26; B60W10/24; B60W2710/0644; B60L2240/486; B60W2710/10; B60K6/44; B60W2710/105.

### U.S. Patent Document:

U.S. Pat. Nos. 3,971,347; 3,858,559; 3,437,079; 4,572,121; 6,244,240; 8,047,824; 4,136,661; 1,576,361; 1,568,053; 3,769,946; 3,873,247; 3,964,447A; U.S. Pat. No. 4,753,073; 5,433,179A; U.S. Pat. Nos. 5,992,371; 6,257,196; 6,886,527; 7,222,601; 7,931,006; 8,037,861; 6,883,473; 6,776,136; 6,761,143; 6,688,276; 6,681,738; 6,675,765; 6,668,786; 6,668,767; 6,659,065; 6,513,482; 6,457,450; 5,345,905; 5,261,365; 5,220,893; 4,688,531; 4,617,886; 4,380,220; 4,227,506; 6,739,307B2; U.S. Pat. Nos. 3,787,150A; 8,613,269; 5,305,721; 6,460,342; 3,933,131; 1,712,945; 3,144,007; 3,228,183; 4,308,002; 3,938,916; 4,079,083; U.S. RE 29,230; U.S. Pat. Nos. 3,955,540; 6,629,829; 7,056,107; 3,585,973A; 3,548,790A; 4,004,556A; 3,572,030A; 3,452,725A; 3,301,233A; 1,032,1443; 4,384,833A; 6,349,695B1; 6,659,066B1; 2,400,286A; 3,614,277A; 5,622,149A; 6,070,565A; 3,451,381A; 5,685,269A; 7,614,382B2; 3,762,375A; 582,389A; 5,937,820A; 3,181,509; 4,168,941A; 6,125,814A; 6,688,865B1; 3,892,502; 4,667,468A; 4,241,713A; 3,568,645A; 3,873,253A; 3,782,110A; 3,164,139A; 2,373,791A; 2,638,880A; 3,186,383A; 4,403,581; 4,476,826; 5,086,732; 5,277,158; 6,003,486; 6,513,482; 6,550,443; 9,546,594; 9,850,835;
Ford Motor Company Patents: U.S. Pat. No. 3,833,321; GB1,460,229; U.S. Pat. No. 3,890,069; CA1,030,743; CA1,045,553; U.S. Pat. Nos. 3,824,746; 3,916,738; 3,964,367; 7,077;
All of the above inventions do not contain the novelty aspects of the present offered invention.

### BRIEF SUMMARY OF THE INVENTION

Present invention rotary vane internal combustion engine comprising of two nested rotors 3 and 4, wherein each rotor has at least two radial vanes, rigidly attached to the rotor or integrally formed with the rotor, rotates within the cylindrical cavity of the housing 9 to form at least four chambers in which occurs the intake I, compression C, combustion S and exhaustion E. The nested rotors assembled as one part, wherein each one side of the vanes are closed by rigidly mounted side washer 5 that eliminates need to seals of the chambers. Each nested rotor 3 and 4, alternately engages with an axial shaft 1 by means of overrunning one-way clutches 8, which ensures its continuous rotation by attaching one rotor and free passing through the other rotor, and in contrary. To avoid the reverse rotation of rotors 3 and 4 and ensure continuous, smooth rotation of shaft 1 applied the adjustable flywheels 12, which are connected with unlocked rotor through holding cushioning mechanism allowing, maintain positioning in the inertial rotation rotors with shaft. Those eliminate the need for the use of unreliable mechanisms of synchronization of the movement between vanes. In order to avoid heating of the overrunning one-way clutches 8, they are placed outside of the heating zone, which is separated from heating zone by a cavity of cooling pump, and has easy access for services. On the outer side of washer 5 of the assembled rotors 3 and 4 is mounted the left/right blends 28 and 29, that with cap 6 formed a pump from two cooling chambers that provide circulation of the cooling fluid around rotors through housing due to by at least two holes in the housing and at least two longitudinal grooves in the shaft. Application in present invention integrated the housing cooling and the rotary cooling systems provide more effective circulation of the coolant that allow significantly increase reliability of rotary vane internal combustion engine.

In order to eliminating sliding friction in the engine of the present invention used the graphite roller seals 18 and 19 for cylindrical surface and conical seals 17 for end surfaces that excludes the need of intensive lubrication. Thus in the present invention is created outstanding conditions for cooling and lubrication of engine, it is means that it should be usable.

Engine start is carried out by the forcible fuel injection using the inlet valves 26 manageable by pressure-sensitive valves 27. The inlet valves 26 are using one time on start for two chambers at the same time, like the suction and combustion compression to allow for balanced compression ratio, which to be corresponded to certain value. After which the ignition is activated (triggered) in the first chamber S thereby leads under ignition a second chamber C, and the engine continues to work in a traditional (regular) cycle, wherein is sufficient condition for starting up of engine operation.

Below is the detailed description of the invention. Conventionally on the drawings is shown that mean the overrunning one-way roller clutches, but it doesn't exclude application of electromagnetic or other one-way clutches.

The proposed engine in the work is equivalent to eight-piston engine, if using two vanes on each rotor, whereas for one revolution realizes four running cycles or as to sixteen piston engine, if using four vanes on each rotor, whereas for one turn realizes eight running cycles;

### BRIEF DESCRIPTION OF THE DRAWINGS

FIG. 1 is a section view along the axis line of rotary vane internal combustion engine of the present invention;

FIG. 2 is a transverse section along the lines A-A of FIG. 1 of rotary vane internal combustion engine of the present invention;

FIG. 3 is an exploded perspective view of the nested rotors of rotary vane internal combustion engine;

FIG. 4 is a perspective view of the assembled rotor of rotary vane internal combustion engine of the present invention;

FIG. 5 is a perspective view of the assembled disclosed middle part of rotary vane internal combustion engine of the present invention;

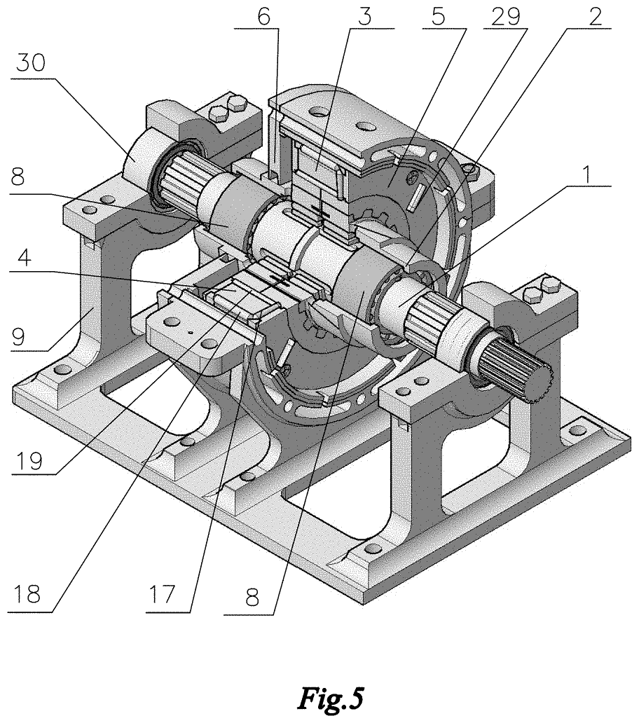

FIG. 6 is a detail out of the section view D in FIG. 1 of rotary vane internal combustion engine;

FIG. 7 is a transverse section along the lines B-B on FIG. 1 of the rotor holding cushioning mechanism of rotary vane internal combustion engine, the present invention;

FIG. 8 is a perspective view of the assembled rotary vane internal combustion engine with the disclosed mechanism of the rotor holding cushioning mechanism of the present invention;

FIG. 9 is a perspective view of the assembled rotary vane internal combustion engine of the present invention;

FIG. 10 is an engine starting schema with forcible fuel injection of rotary vane internal combustion engine of the present invention;

FIG. 11 is schematically illustrated multivariate relationship of chambers volume and torque, which provide optimize the efficiency of a rotary vane internal combustion engine of the present invention;

FIG. 12 is a section and perspective views of the roller and conical seals of rotary vane internal combustion engine of the present invention;

### DETAILED DESCRIPTION OF THE INVENTION

The present invention is one embodiment of a rotary vane internal combustion engine where torque on the shaft is produced due to alternating interaction of the rotors within. The rotors placed in housing between two cooling chambers, around which cooling fluid is circulated, have conical and cylindrical graphite seals to eliminate friction between the work surfaces. This invention relates to improvement of rotary vane internal combustion engine and will be described with reference to the following drawings.

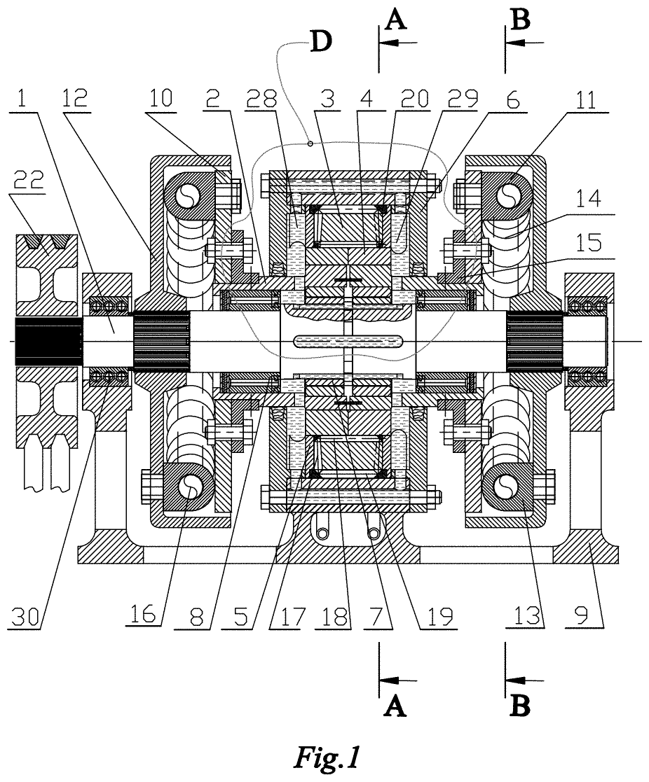

As shown on the drawing FIG. 1, rotary vane internal combustion engine related to one embodiment of the present invention comprising a housing 9, inside which set a shaft 1, which interacts with rotors 3 and 4 through one-way overrunning clutches 8, which are rigidly joined with rotors 3 and 4 by adapters 2. The one side of each rotor is rigidly closed by flanges 5, which are formed with caps 6 the chambers for circulation the cooling fluid to use mounted on flanges 5 the right and left blades 28 and 29. The drawing in FIG. 1 shows the mechanism of the rotor holding cushioning mechanism where flywheels 12, rigidly mounted on shaft 1, interact with rotors 3 or 4 using the damper 14, fitted on the guide 16. The one end of the guide 16 is rigidly mounted on flywheel 12 using adjustable holder 13, the other end using holder 11, mounted on washer 10, which is rigidly connected with rotor 3 or 4 using adapters 2. The drive shaft 1 is installed on the two bearings 30 and on the middle bearing shells 7, hereby are supported in three places that provide good conditions of work, and at least one end of the shaft is for transferring torque.

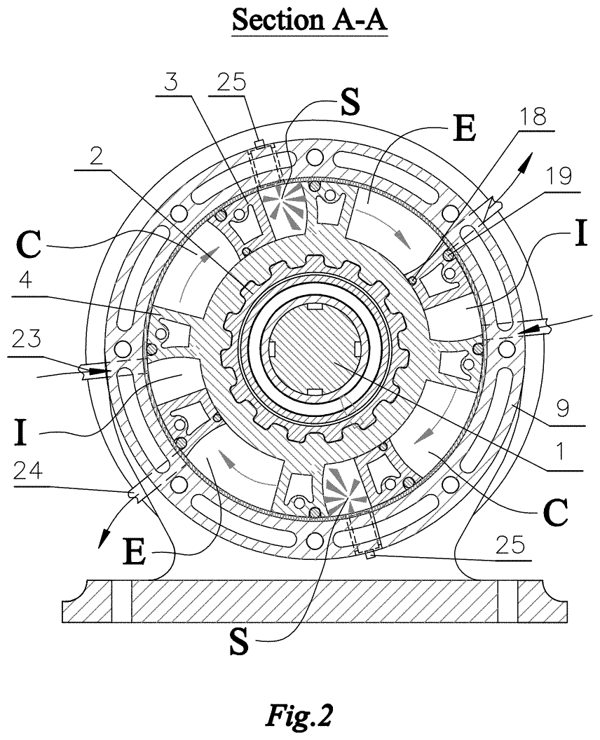

For the purpose of demonstration of the principles of work the present invention is illustrated on the drawing FIG. 2, section A-A, where the rotors 3 and 4, having four (at least two) vanes, which established in the housing 9, to provide eight (at least four) chambers, as intake I, compression C, explosion S, and exhaustion E, accordingly chambers I and E have fitting systems of 23, 24 for provide fuel supply and exhaust gases. On the rotors 3, 4 that are rigidly connected with adapter 2, we can see the seals 18 and 19. Engine start is carried out by the forcible fuel injection using the inlet valves 26 manageable by pressure-sensitive valves 27 that provides balanced compression ratio one time in two chambers.

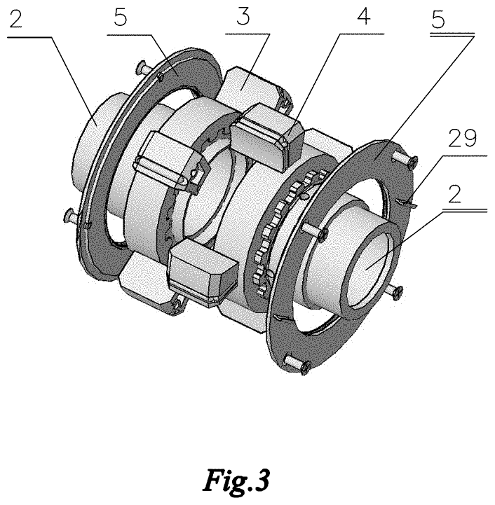

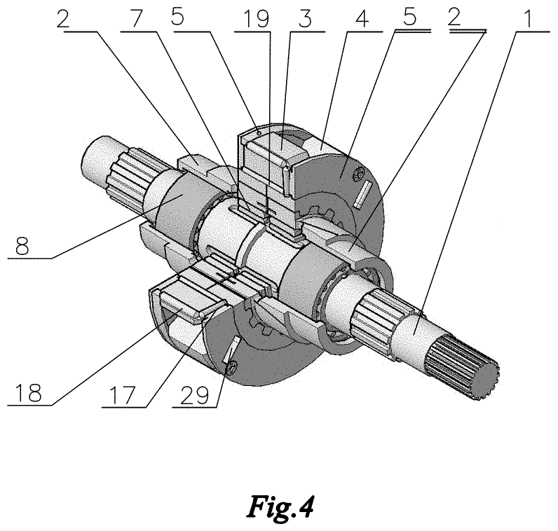

Drawing FIG. 3 shows an exploded and on the FIG. 4 assembled nested rotors 3 and 4, which closed by two flanges 5 with the cylindrical 19 and conical 17 seals. On the said flanges are mounted bland 29 for pumping cooler.

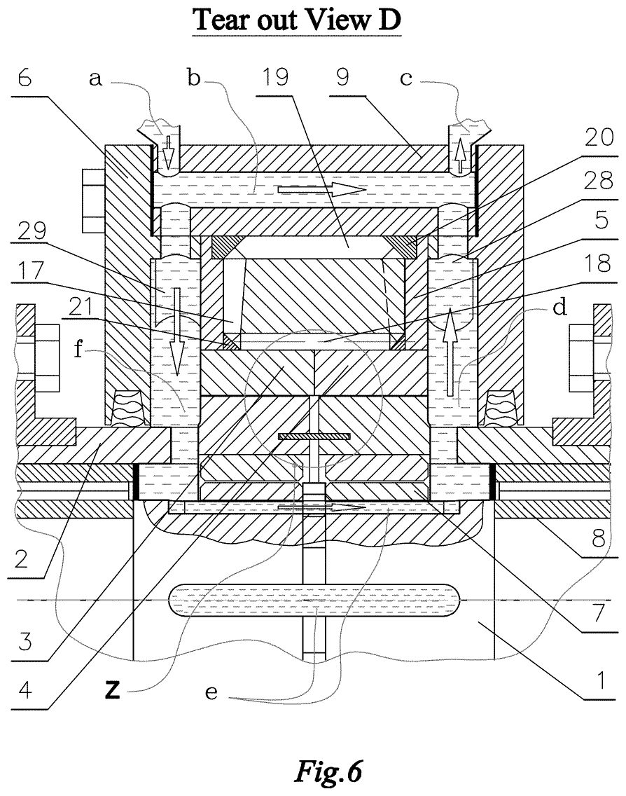

On the drawing FIG. 6, a demonstration of the principle of cooling system, which is a detailed out of the cut-away D of FIG. 1 of rotary vane internal combustion engine of the present invention with traced all the way (a, b, c, d, f and e) of following the coolant. The coolant enters the engine through the holes—a from the tank, distributed into cavity of the housing—9 and cavity between rotor and housing cap of left side, passes through holes—f of the adapter—2 and through groove—e of the shaft—1 enters into cavity of right side—d, then coolant returns in to tank through hole—c. The right and left blades 28 and 29 located on flange 5 provide circulation of the coolant. As well on the cut-away section D, shown the conical 17, cylindrical 18 and 19 graphite seals with sealing rings 20 and 21 that are installed in the assembled rotor. The proposed solution to place the overrunning clutches 8 outside of the heating area of the engine to provide reliable operation of the engine. On the cut-away D is illustrated one of the important decisions of the present invention.

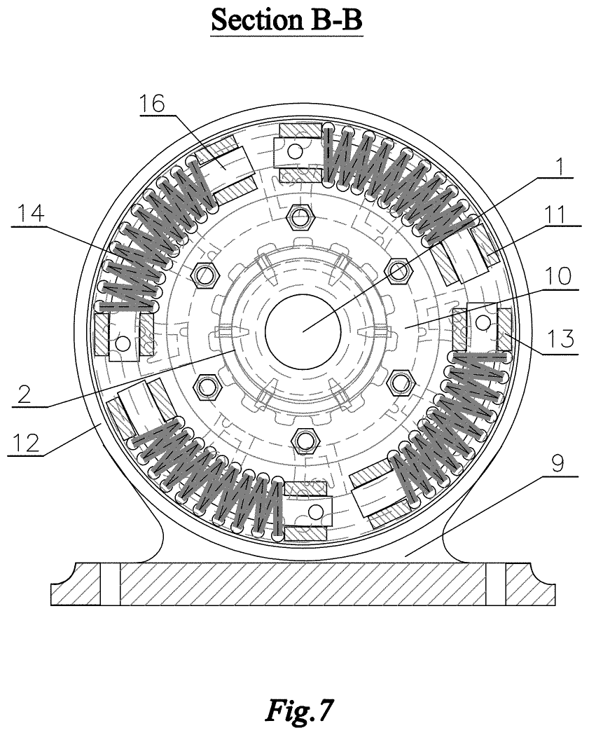

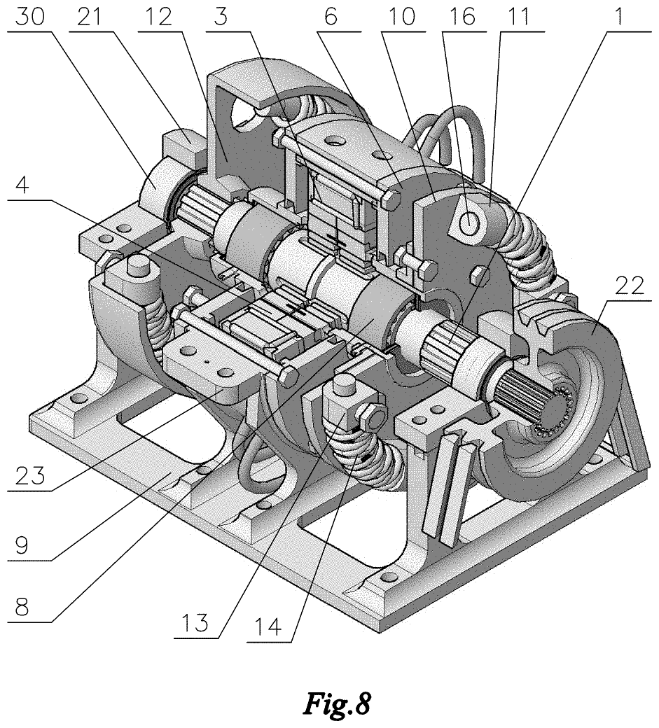

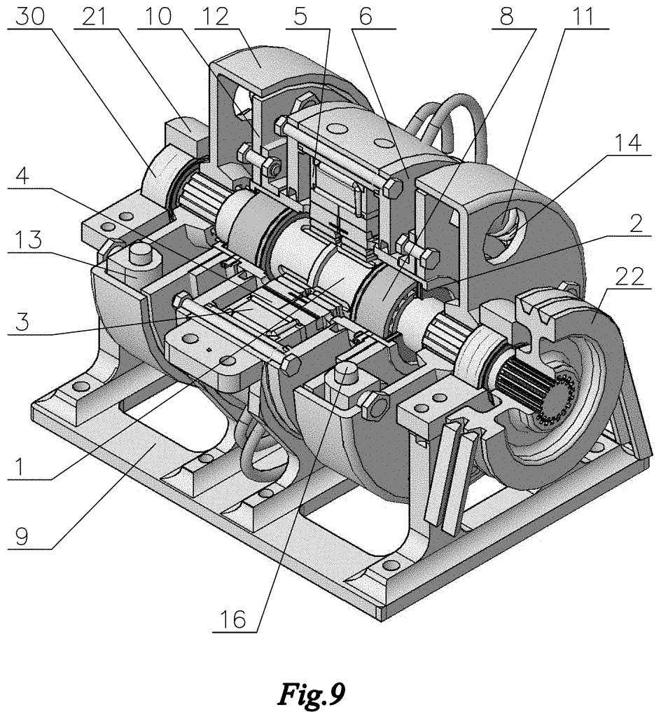

The principle of work a holding cushioning mechanism, which holds the rotor 3 or 4 from turning back is illustrated on the drawings FIG. 7, which is section B-B of FIG. 1, and on the perspective view FIG. 8, where the shaft 1 is in engagement alternately with one of rotor (for example 3) and passes freely through the other rotor (is 4), which rotates with the shaft 1 due to a damper 14, which holds the said rotor 4 until the cycle changes. The process of the disconnecting rotor 3 or 4 from the shaft 1 is controlled by said holding cushioning mechanism that can be adjusted by holder 13 that is rigidly mounted on the washer 10 which in its turn is rigidly connected with adapter 2. On the drawing FIG. 9 showed a perspective view of the assembled rotary vane internal combustion engine, where the shaft 1 installed on to bearings 30 and on the bearing shells 7 that provide reliable operation of the engine of the present invention. Transmission of engine torque from the drive shaft 1 is carried out through belt or gear connector 22.

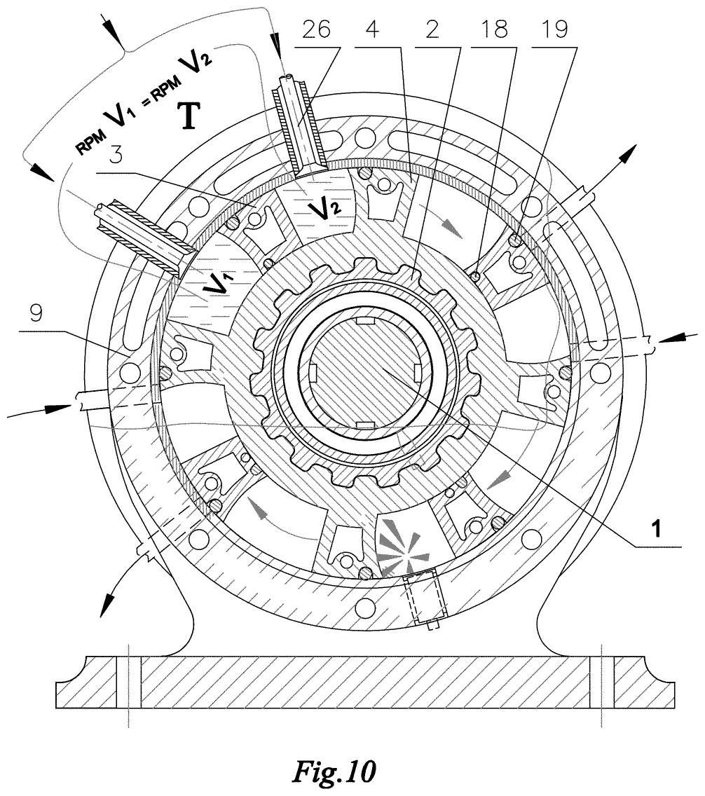

FIG. 10 shows schematically the optimization of the relationship between volume of chambers and torque of rotary vane internal combustion engine of the present invention.

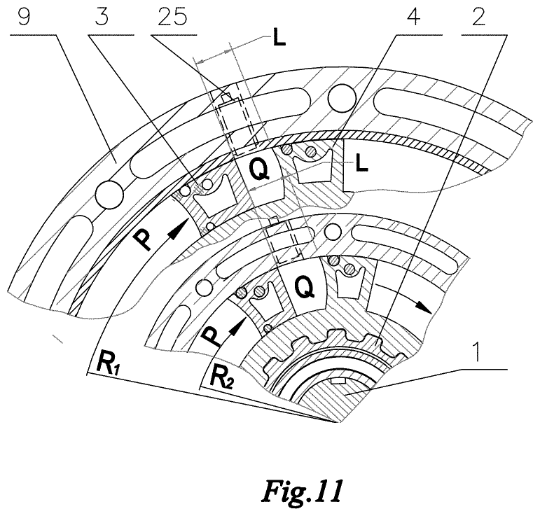

FIG. 11 shows schematically the optimization of the relationship between volume of chambers and torque of rotary vane internal combustion engine of the present invention. Design is made in such a manner that it enables calculation of the optimal size of the radius R2 of force application P, for the planned volume of the chambers, as P×R1<P×R2, given constant volume of chambers.

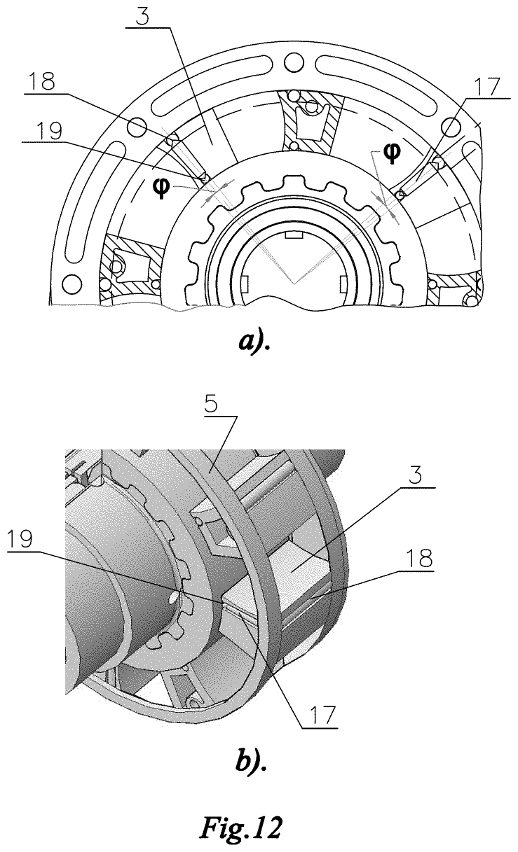

On the drawing FIG. 12 shows section and perspective views of the roller 18 and 19, and conical 17 graphite seals that is detailed on the cut-away D of FIG. 6 of rotary vane internal combustion engine of the present invention;

### DESCRIPTION AND OPERATION OF THE INVENTION

The present invention will now be explained in greater detail with the reference to embodiments, which are represented in the accompanying drawings, wherein:

Engine start is carried out by the forcible fuel injection using the inlet valves 26 managed by pressure-sensitive valves 27, FIG. 10. The fuel supply is carried out at the same time, into chambers compression C and combustion S, where pressure is the same. When pressure is sufficient, the sensor gives command to start ignition. Delivery of fuel into chambers C and S occurs only at the moment of engine start. Ignition is activated at a certain pressure in the system and due to expansion of gas the vanes of rotors begin move in different directions, with one of the rotors 3 or 4 entering into gearing with leading shaft 1 due to the overrunning clutch 8, the other rotor stationary on the shaft and is holding on the shaft by flywheel 12 from returnable rotation, but continues to rotate together with it. After the forcible fuel injection into two chambers C and S, first start-up begins the combustion in chamber S, where the ignition of fuel occurs and vane provide moving a shaft thereby swapping for igniting the next chamber C. The two movements of the chambers are enough for engine to begin work in regular cycle: absorption, compression, combustion, exhaustion. The leading shaft 1 attached to the one of the rotor 3 or 4 and free passing through the other rotor alternately connecting with the one way clutch 8 to provide moving rotors apart.

In this way each rotor alternately engages with the shaft and continues to rotate even when it is disengaged from the shaft due to retention by a flywheel 12, as shown on FIGS. 1, 7, 8. The flywheels consist of two parts, washer 10 and flywheel 12, where one of them, washer 10 is connecting with rotor and the other, body of 12 is connecting with shaft 1. Between them there is a damper, with one end mounted on the washer 10 and the other on the body of flywheel 12. Damper force is adjusted by means of the holder 11 so that the back movement is sufficient only when disconnected the shaft from a rotor.

The one of main point of the present invention is that the whole system (rotors, shaft, and clutches) is rotating with high speed, but inside system is the alternating movement of the rotors and other components that has eliminated impact and loads and provides good reliability, and not used reciprocating movement mechanisms, such as crankshaft, rocker arm or others.

The two rotors are assembled so that they form at least four closed chambers and pressure inside chambers have a positive effect on friction between rotors 3 and 4 (zone Z, FIG. 6), which keeps them without contact. In order to provide better conditions for the engine to eliminate friction between surfaces applied the cylindrical 18, 19 and conical ferrite seals 17 and to decrease the gap between seals rings are used 20, 21.

The next major advantage of the present invention is that the design is carried out in such a manner that the whole system (rotors, shaft, and clutches) is inside the circulating lubricating coolant. This is made possible due to the existing cavity between the rotor 3, 4 and the housing cap 6 as a built-in pump. It means that on each outer side of the assembled rotor, on flange 5, mounted the left/right blade 28/29, that provides circulation of the cooling fluid around rotors through housing and groove in the shaft. The coolant enters the engine from the tank through the holes a, distributed into cavity of the housing 9 and cavity between rotor and housing cap 6 of left side FIG. 6, passes through holes f in the adapter 2 and through groove e of the shaft 1 enters into cavity of right side d, then coolant returns into tank through hole c, that means that engine can be readily cooled and lubricated, that mean it is not susceptible to overheating. The presented design of the engine allows for working conditions of one-way overrunning clutches 8, which is separated from the heating zone by a cavity of cooling pump.

### Advantages

The main advantages of the invention are reliability, simple of manufacture and ease of maintenance, durability and high efficiency of the proposed rotary vane internal combustion engine, in which:
Reciprocating movement mechanisms are not used;
No need to synchronize the rotation of the rotors, since the rotors do not have a rigid connection with each other;
The engine is not subject to overheating, since the main working assembly of the rotors, closed by the side flanges, is located in the cooling bath.

The present invention eliminates the disadvantages of existing designs of rotary vane internal combustion engines by efficiently utilizing a system of alternately-rotating vanes using overrunning clutches and by efficiently utilizing the rotors holding cushioning mechanism that provides continuous shaft rotation, being in favorable environment, due to the efficient use of the cooling system.

The working chambers formed by the vanes are rigidly closed by flanges on both sides, which reduces the number of rubbing surfaces, and roller and conical seals are installed on the remaining rubbing surfaces, which ensure the engine runs without lubrication;

In the proposed embodiment, a simplified engine starts due to a single injection of fuel into two adjacent compression and combustion chambers using a high pressure compressor, after which the engine continues to operate normally.

The possibility of creating a wide range of engines in terms of power and fuel consumption is also expanded, which is due to the lack of a direct relationship between the volume of the chambers and the working diameter of the cylinder of a rotary vane internal combustion engine.

The present invention aims to increase efficiency up to 70%.

The engine proposed in this work is equivalent to an eight-piston engine when using two vanes on each rotor, at this time four working cycles are carried out in one revolution, or to a 16 piston engine when four vanes are used on each rotor, that is, in one revolution it implements eight working cycles.

The present invention of a rotary vane internal combustion engine can more effectively be used for sports cars and hybrid cars.

### CONCLUSION

Rotary vane engines, the most promising of all currently used internal combustion engines. In serial industrial production, there is no working sample from this rather large family. There are only a few experimental models that are still very far from perfect.

The main reason for the lack of a working design for this engine type is that during rotation, due to the enormous inertial load, the mechanisms used to coordinate the rotation of the rotors and the associated rotor vanes are quickly destroyed, and the difficulty of removing heat from the working zone is no less important. The proposed design of the rotary vane internal combustion engine eliminated these drawbacks, which allowed us to create a new type of rotary vane machines that are easy to manufacture, reliable and highly efficient. The significant advantages of the present rotary vane internal combustion engine of the present invention are reflected in the “Advantages” section. We can expect that they are destined for a great and bright future.

I claim:

1. Rotary vane internal combustion engine, rotary machine comprising: placed in the cylindrical housing two rotors, nested one inside the other said rotor, each having at least two radial vanes, rigidly attached to said rotor, which forms at least four chambers in which occurs intake, compression, combustion and exhaustion, wherein each said rotor alternately engages with a shaft by the overrunning one-way clutches, which are rigidly fixed to the said shaft, and which alternately enter into engagement with the said shaft and rotate it continuously.

2. Rotary vane internal combustion engine, rotary machine as recited in claim 1, wherein on the said shaft rigidly mounted two flywheels that relate to said rotors through holding cushioning mechanism that holds the alternately unlocked said rotors from turning back, wherein the said holding cushioning mechanism has adjustable stroke.

3. Rotary vane internal combustion engine, rotary machine as recited in claim 1, wherein each outer side of said rotor assembly is rigidly closed by side flanges, thereby ensuring tightness of the assembly, and at least one blade is mounted on each of them.

4. Rotary vane internal combustion engine, rotary machine as recited in claim 3, wherein in between said assembled rotors with outer said blades and the covers of said cylindrical housing two cooling chambers are formed through which circulates cooling liquid circulates using openings in said housing and through at least two longitudinal grooves in said shaft.

5. Rotary vane internal combustion engine, rotary machine as recited in claim 1, wherein in that cylindrical seals are installed between the cylindrical surfaces of said blades and said housing, and conical seals are installed between the side surfaces of said blades and the inner surfaces of said flanges, which eliminating the need for lubrication.

6. Rotary vane internal combustion engine, rotary machine as recited in claim 1, wherein engine start is carried out by disposable injection the fuel by compressor into said compression and combustion chambers at the same time after which the engine enters normal mode.
